(19) United States
(12) Patent Application Publication
(10) Pub. No.: US 2022/0144189 A1
(43) Pub. Date: May 12, 2022

(54) MATERIAL STRUCTURE OF A NEEDLED NONWOVEN

(71) Applicant: ADLER PELZER HOLDING GMBH, Hagen (DE)

(72) Inventors: Siegfried BERNHARDT, Bremen (DE); Volkmar SCHULZE, Schierling (DE); Matthias DICKERT, Witten (DE); Ray SINGH, Schwelm (DE); Andreas HART, Dortmund (DE)

(73) Assignee: ADLER PELZER HOLDING GMBH, Hagen (DE)

(21) Appl. No.: 17/433,937

(22) PCT Filed: Feb. 18, 2020
(86) PCT No.: PCT/EP2020/054203

§ 371 Date: Aug. 25, 2021

(30) Foreign Application Priority Data
Feb. 26, 2019 (DE) 10 2019 104 847.8

(51) Int. Cl. B60R 13/08; B32B 5/06; D04H 1/559; D04H 1/498

(52) U.S. Cl. CPC B60R 13/0861; B32B 5/073; B32B 19/06; D04H 1/498; D04H 1/559

(57) ABSTRACT

A needled nonwoven for the manufacture of, in particular, textile wheel arch liners, has different materials in its individual layers across the thickness.

The object of the invention is a multilayer needled nonwoven with a sandwich structure for the manufacturing of especially textile wheel arch liners for motor vehicles, which has different materials in its individual layers across the thickness.

These needled multilayer nonwovens are also used in other exterior components of motor vehicles.

The typical structures of nonwovens, in particular for the production of textile wheel arch liners, include, for example, PP/PET, PP/BiCo, PP/BiCo/PET and/or PET/BiCo mixed fibre nonwovens, in particular in the grammage range from 700 to 1800 g/m².

For the acoustic and mechanical optimisation of a wheel arch liner, absorber fleeces or foams are often applied to the body side of the motor vehicle and foils to the wheel side, body side and in the middle of the sandwich, so that one speaks of single-layer, two-layer, three-layer structures as well as trilaminate, whose middle layer is often an extruded PP layer.

Currently common material build-ups include, for example:

Needle fleece 1350 g/m², PET/PP

Film 70 g/m², PE/PA/PE

Needle fleece 1200 g/m², PET/PP

Film 40 g/m², PE/PA/PE

Cover fleece 80 g/m², PET, laminated in the forming process

Needlefelt absorber 400 g/m², 10 mm PET

Needle fleece 1400 g/m², PET/PP

Film 40 g/m², PE/PA/PE

Cover fleece 110 g/m², PET

Absorber 250-450 g/m², 10 mm PET or PP/PET

Needle fleece 1200-1450 g/m², PP/PET

Needle fleece 300 g/m², PP/PET

Needle fleece 800 g/m², PP/PET/BiCo

Particularly due to the development of e-vehicles, the wheel arch liner is gaining more importance in the acoustic sense, here especially the reduction of rolling noise.

Various designs of material structures are known in the prior art.

DE 10 2007 033 635 A1 describes a nonwoven moulded part for vehicles. In the case of a moulded nonwoven part, the starting point is a nonwoven semi-finished product consisting of several pile layers lying one on top of the other, which are formed differently from one another. Each pile layer consists of a mixture of structure-forming fibres on the one hand and matrix-forming fibres on the other hand. During heat treatment at a defined temperature, only the matrix-forming fibres melt, but not the structure-forming fibres. In order to improve the mechanical and acoustic properties of the moulded part, it is proposed to provide the matrix-forming fibres with a lower melt viscosity and/or a higher melt index than the other pile layers, at least in the pile layer which, in later use, forms the underside of the finished moulded part.

TR 200803410 relates to a process for reusing relatively coarse waste materials, for example textile waste from the manufacturing process of automotive parts and products made therefrom. The process is characterised by breaking the waste materials into relatively small pieces. This ground material is then placed on a base. An upper layer of another raw material is then applied to the surface of the waste material and the layers are bonded together. TR 200906997 describes an analogous process in which another hard layer is also applied.

DE 10 2015 115 458 A1 [WO 2017/046164 A1] discloses a structural component of a motor vehicle, in particular a wheel arch liner or an engine compartment shield, wherein the structural component consists at least partially of a composite material which is pressed from at least two non-woven layers lying one on top of the other. It is proposed here that a reinforcing layer of at least one laid reinforcing filament is arranged on at least one of the non-woven layers to reinforce the composite material.

In US 2018/0251924 A1, a nonwoven composite system is proposed in which two nonwovens are arranged on one side and two nonwovens with an intermediate film on the other side. Specially modified fibres are used in the nonwovens.

Furthermore, methods of manufacturing velour carpets are known, see among others DE 44 09 771 A1 , DE 29 00 935 C2 and DE 10 2008 026 968 A1.

In addition, methods of manufacturingso-called recycled sandwich nonwovens or components are described in the prior art, in which on the one hand the pressing technology (DE 10 2016 202 290 A1) and on the other hand the needling (DE 10 2013 222 403 A1, DE 10 2016 203 348 A1) are used.

WO 2012/052535 A1 relates to a method for producing a composite nonwoven in a continuous process sequence and to an apparatus for carrying out the method. In this process, a fibre pile is formed from a fibre stream by a carding device, on the surface of which a nonwoven layer of synthetic fibres is subsequently laid. For this purpose, the fibre web is guided within a suction zone on a delivery belt to a melt-blowing device, in which the synthetic fibres are laid by melt-blowing on the surface of the fibre web. The fibre pile covered with the nonwoven is then laid in several layers by a nonwoven laying device to form the composite nonwoven.

All nonwoven material constructions described in the prior art do not include different materials needled into the individual layers during manufacture across the nonwoven thickness. Only a regrind/fibre intermediate layer, embedded between two (cover) nonwovens, which are pressed or needled, is reported.

The task of the present invention compared to the aforementioned prior art is thus to provide a multilayer needled nonwoven, in particular for the manufacture of textile wheel arch liners or motor vehicle underbody panels, which has properties defined via the nonwoven thickness by a layer-specific needle punching of identical or different materials.

In this way, it is possible to specifically influence the requirements demanded by the OEM and laid down in the corresponding specifications, in particular already during the production of the initial nonwoven itself.

In a first embodiment, the object of the present invention is a needled nonwoven for the production of, in particular, textile wheel arch liners comprising 5 to 14 individual pile layers with a grammage of the nonwoven in the range from 650 g/m² to 1900 g/m², the base nonwoven comprising PP/PET, PP/BiCo/PET, PP/BiCo or PET/BiCo fibres, which is characterised by the fact that

the individual layers—corresponding in particular to the acoustic and mechanical requirements of a textile wheel arch liner—are each made of the same or different materials of ground material and/or fibres.

and/or flakes and/or powder in layers of equal or different amounts.

The core of the present invention is thus the provision of a multi-layer needled structure, in the manufacture of which acoustic and mechanical properties are modified or optimised by interspersing the same or different materials in and between the individual layers.

The advantage of the present invention thus consists in the provision of deformation-appropriate/stable nonwovens for the production of, in particular, wheel arch liners with a property-optimised structure, namely the integration of the property-optimising individual materials at the point of action already during the nonwoven production.

A method according to the invention for the production of needled nonwovens, which makes it possible to introduce identical or different materials via the thickness of the nonwoven into the individual layers during their production, is characterized in that

(a) by means of scattering devices, which are located between the doffer conveyor belts of a carding machine, one intersperses identical or different materials as ground material and/or fibres and/or flakes and/or powder between the fibre piles in accordance with the requirements, in particular acoustic and mechanical requirements, of a textile wheel arch shell,

(b) the switching on/control of the spreading devices takes place according to the required regrind and/or fibre and/or flake and/or powder material type and quantity,

(c) one lays the fibre pile with the regrind and/or fibre and/or flake and/or powder material types into a single layer, lays the individual layers into a fleece and

(d) one needles the laid material composite.

The interspersing of different materials in the individual layers of a nonwoven—during their production—is also not found in the prior art. Likewise, a variation of the quantity over the width of the individual layers is not known. In this case, for example, less ground material is interspersed at the outer edge of the nonwoven material than in the central areas. Just as it is possible to reduce the layering profile by smart control of the speed of the compensating stacker or the pile weights, it is possible according to the invention to vary the quantity spread not only per layer (i.e. over the thickness), but also over the width of the roll.

Edge areas could be designed stiffer, e.g. to achieve higher pull-out strengths of fastening points. Central areas could be designed to be more extensible.

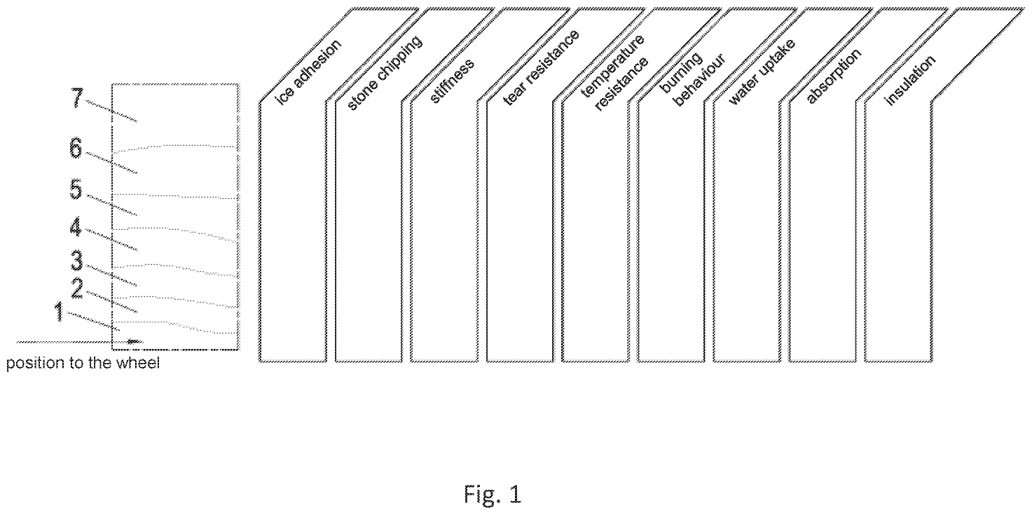

FIG. 1 shows an example of the “matrix” according to which a regrind/fibre selection can be put together in accordance with the acoustic and mechanical properties.

As already mentioned above, the following materials, among others, are used as spreading material in the individual layers, which influence the following properties:

Acoustics: Hollow fibres with different cross-sectional geometry,

GF/BiCo/PET ground/fibrous material, foam flakes

Water absorption: hydrophobised fibres (incl. H-PET), GF/PP/BiCo ground/fibrous material

Stone chipping : PP/PE ground/fibrous material

Ice accumulation/adhesion : hydrophobised fibres (incl. H-PET), PP/PET ground material

Stiffness: carbon fibres, natural fibres

Temperature resistance: PP/GF ground/fibre material, mineral fibres, glass fibres (GF)

Burning behaviour: GF/Panox/PET/BiCo ground/fibre material, flame retardant, flame retardant treated fibre, mineral fibres, glass fibres

Tear resistance: Aramid fibres

### EXAMPLE OF EXECUTION

### Example 1

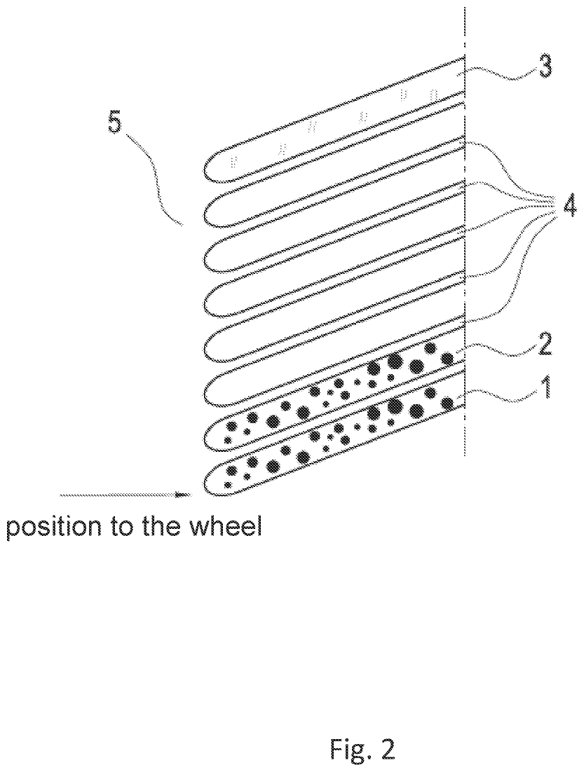

For the production of a deformation-resistant/stable nonwoven, 5, comprising 8 individual layers with a total grammage of 1200 g/m² for the production of textile wheel arch liners (see FIG. 2). 2), 120 g/m² of PET/PP ground material mixed with hydrophobised PET short fibre material is scattered into a first layer, 1, and a second layer, 2, later facing the wheel, and 150 g/m² of PP/PET/BiCo ground material is scattered into the outer layer, 3, later facing the car body, and needled into the composite, the base fleece, 4, itself consisting of 40% PP and 60% PET fibres.

The fleece is then formed into wheel arch shells using standard processes [contact heating field (T=200° C.; t=50 sec; gap width=4 mm), tool (T=20° C.; t=50 sec; gap width=3 mm)].

Due to the material scattered on the wheel side, the wheel arch liner has improved behaviour in terms of stone impact resistance, water absorption and ice accumulation.

### Example 2

With the aim of improving the wheel arch strength/stiffness, a fleece is produced from 10 layers with a grammage of 1400 g/m². In the first layer facing the wheel, 150 g/m² of PP/PET/BiCo ground material is interspersed, in the second layer following the first layer 150 g/m² of PP/PET/BiCo ground material is interspersedand in the seventh layer facing the car body, 150 g/m² of PP/PET/BiCo/carbon fibre ground material is interspersed, laid into a composite and needled in the composite, whereby the base fleece itself consists of 40% PP and 60% PET fibres. The wheel arch liners produced from this meet the specifications with regard to the increased strength requirements.

1. Needled nonwoven for the production of, in particular, textile wheel treads for motor vehicles, containing 5 to 14 individual nonwoven layers, with a grammage of the nonwoven in the range from 650 g/m² to 1900 g/m², the base nonwoven comprising PP/PET, PP/BiCo/PET, PP/BiCo or PET/BiCo fibres, wherein
the individual layers—corresponding in particular to the acoustic and mechanical requirements of a textile wheel arch liner—comprise identical or different materials as ground material and/or fibres and/or flakes and/or powder in identical or different quantities in layers and needled in the material composite.

2. Use of a needled nonwoven according to claim 1 for the manufacture of motor vehicle exterior components.

3. A process for the production of needled nonwovens according to claim 1, wherein
by means of scattering devices, which are located between the doffer transport belts of a carding machine, the same or different materials are interspersed as ground material and/or fibres and/or flakes and/or powder between the fibre piles in accordance with the, in particular, acoustic and mechanical requirements of a textile wheel arch shell, the switching on and/or control of the scattering devices takes place in accordance with the required material type and quantity,
the fibre piles with the intermediary regrind and/or fibre and/or flake and/or powder material types are each placed in a single layer,
one lays the individual layers into a fleece, and
the laid material composite is needled.

4. The process according to claim 3, characterised in that the same or different materials are used as ground material and/or fibres and/or flakes and/or powder. interspersed in layers across the width of the fleece in varying amounts (g/m²).
